(19) United States
(12) Patent Application Publication
(10) Pub. No.: US 2022/0188747 A1
(43) Pub. Date: Jun. 16, 2022

(54) ASSORTMENT PLANNING COMPUTER ALGORITHM

(71) Applicant: International Business Machines Corporation, Armonk, NY (US)

(72) Inventors: Kushagra Manglik, Lucknow (IN); Abhishek Bansal, New Delhi (IN); Vijay Ekambaram, Chennai (IN); Vikas C. Raykar, Bangalore (IN)

(21) Appl. No.: 17/123,201

(22) Filed: Dec. 16, 2020

(51) Int. Cl. G06Q 10/08; G06N 5/04; G06Q 30/06; G06Q 10/04; G06Q 30/02; G06Q 10/06

(52) U.S. Cl. CPC G06Q 10/087; G06N 5/04; G06Q 30/0631; G06Q 30/0633; G06N 20/00; G06Q 30/0202; G06Q 10/06315; G06Q 30/0641; G06Q 10/04

(57) ABSTRACT

Machine logic for selecting a given item for an inventory. This selection of the given item is based, at least in part, upon: (i) an amount of “ensembles” that include the item; (ii) relative popularity of “ensembles” that contain the item; and/or (iii) the relative profitability of ensembles that includes the item. This technology can be provided as part of assortment planning software for retail stores selling items such as: fashionable clothing, furniture sets, jewelry sets, and other types of items that are typically sold in ensembles and have subjective factors (like aesthetics) that play into the attractiveness of the ensemble considered as a whole.

### BACKGROUND

The present invention relates generally to the field of assortment planning, and more specifically to assortment planning performed, at least in part, by machine logic running on a set of computer(s).

The Wikipedia entry for retail assortment strategy (as of 5 Aug. 2020) states in part as follows: “Assortment strategies are used by retailers in brick-and-mortar and ecommerce to decide on a daily basis how to allocate inventory to their stores as part of their merchandise planning processes. Such strategies are integral for retailers because they directly affect how their customers interact with their merchandise, and therefore, their brand. The decisions that these strategies help make are what to sell, where to sell it, when to sell it, whom to sell it to, and how much to sell.” (footnotes omitted)

In a passage dealing with “assortment planning,” the Wikipedia entry for retail assortment strategy (as of 5 Aug. 2020) further states in part as follows: “Assortment planning is the process to determine what and how much should be carried in a merchandise category. Assortment plan is a trade-off between the breadth and depth of products that a retailer wishes to carry. Assortment optimization refers to the problem of selecting a set of products to offer to a group of customers to maximize the revenue that is realized when customers make purchases according to their preferences. Assortment affects costs because it drives inventory decisions. Poorly conceived inefficient assortments raise inventory costs and waste valuable shelf space. Assortment optimization is essential to a wide variety of application domains that includes retail, online advertising, and social security. The process brings order out of the mind-numbing complexity of thousands of SKUs across scores of markets and retailers. This process demands internal alignment within manufacturers and retailers before they enter into a collaborative process with one another. Like inventory optimization, assortment optimization too takes demand and supply volatility into account.” (footnotes omitted)

### SUMMARY

According to an aspect of the present invention, there is a method, computer program product and/or system that performs the following operations (not necessarily in the following order): (i) receiving a candidate data set that includes identifying information for a plurality of candidate items are available that be stocked in an inventory of a store; (ii) determining a plurality of candidate ensembles, with each candidate ensemble being made up of at least three candidate items of the plurality of candidate items; (iii) for each given candidate item of the plurality of candidate items, determining a number of candidate ensembles to which the given candidate item belongs to determine an ensemble-compatibility rating for the given candidate item; and (iv) selecting a plurality of recommended inventory items from the candidate items, based, at least in part, upon the ensemble-compatibility ratings of the candidate items.

According to an aspect of the present invention, there is a method, computer program product and/or system that performs the following operations (not necessarily in the following order): (i) receiving a candidate data set that includes identifying information for a plurality of candidate items are available that be stocked in an inventory of a store; (ii) determining a plurality of candidate ensembles, with each candidate ensemble being made up of at least three candidate items of the plurality of candidate items; (iii) for each given candidate item of the plurality of candidate items, determining an ensemble-compatibility rating for the given candidate item based, at least in part, upon relative predicted popularity of candidate ensembles to which the given candidate item belongs; and (iv) selecting a plurality of recommended inventory items from the candidate items, based, at least in part, upon the ensemble-compatibility ratings of the candidate items.

According to an aspect of the present invention, there is a method, computer program product and/or system that performs the following operations (not necessarily in the following order): (i) receiving a candidate data set that includes identifying information for a plurality of candidate items are available that be stocked in an inventory of a store; (ii) determining a plurality of candidate ensembles, with each candidate ensemble being made up of at least three candidate items of the plurality of candidate items; (iii) for each given candidate item of the plurality of candidate items, determining an ensemble-compatibility rating for the given candidate item based, at least in part, upon all of the following: (a) relative predicted popularity of candidate ensembles to which the given candidate item belongs, (b) number of candidate ensembles to which the given candidate item belongs, and (c) profit margins associated with the candidate ensembles to which the candidate item belongs; and (iv) selecting a plurality of recommended inventory items from the candidate items, based, at least in part, upon the ensemble-compatibility ratings of the candidate items.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIGS. 5A and 5B collectively make up a flowchart showing a second embodiment method;

FIG. 6 is a more detailed view of a portion of the flowchart showing the second embodiment method;

FIG. 7 is a more detailed view of a portion of the flowchart showing the second embodiment method;

FIG. 8 is a more detailed view of a portion of the flowchart showing the second embodiment method;

FIGS. 9A and 9B are graphs used in performing the second embodiment method;

FIG. 10 is a more detailed view of a portion of the flowchart showing the second embodiment method;

FIG. 11 is a more detailed view of a portion of the flowchart showing the second embodiment method; and

FIG. 12 is a more detailed view of a portion of the flowchart showing the second embodiment method.

### DETAILED DESCRIPTION

Some embodiments of the present invention are directed to machine logic for selecting a given item for an inventory. This selection of the given item is based, at least in part, upon: (i) an amount of “ensembles” that include the item; (ii) relative popularity of “ensembles” that contain the item; and/or (iii) the relative profitability of ensembles that includes the item. This technology can be provided as part of assortment planning software for retail stores selling items such as: fashionable clothing, furniture sets, jewelry sets, and other types of items that are typically sold in ensembles and have subjective factors (like aesthetics) that play into the attractiveness of the ensemble considered as a whole. This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

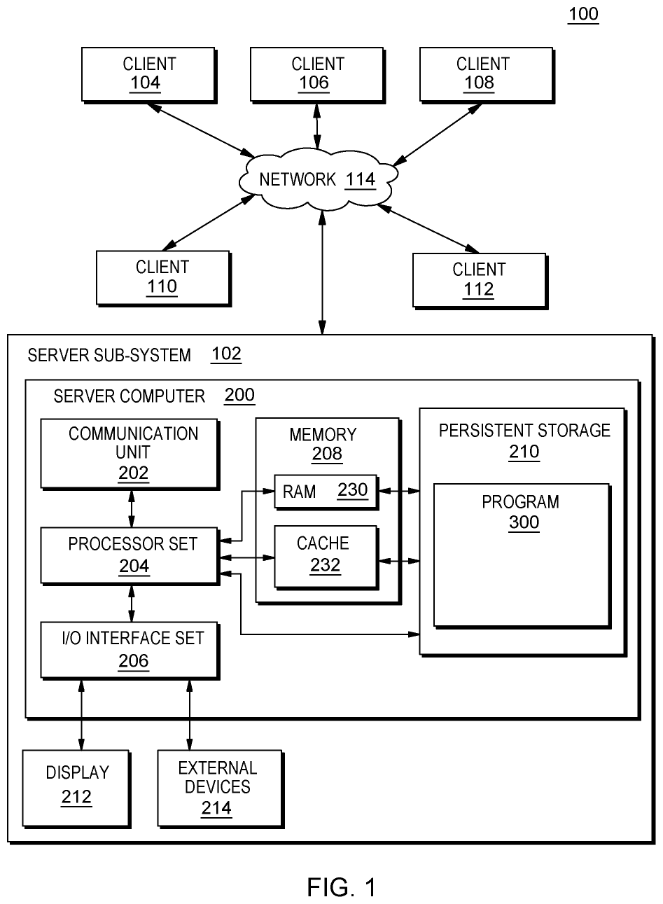

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

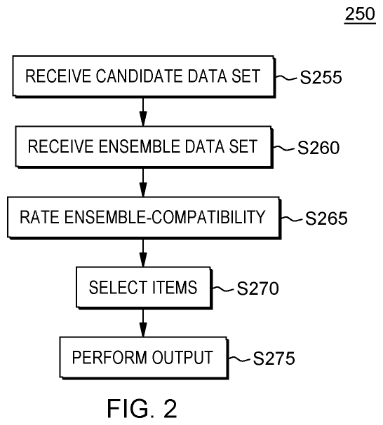

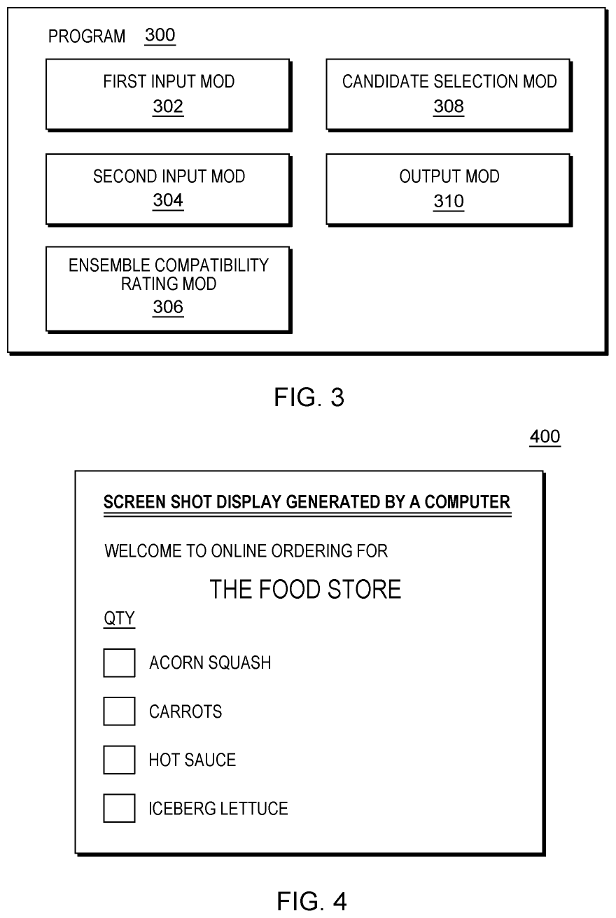

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

The example of the method of flowchart 250 is based on a store that sells only four (4) items, which is to say, a store that only keeps four (4) items stocked in the store's inventory. In this example the store is a food store that carries only four (4) types of food in its inventory. The food store sells its items in two different ways: (i) as individual items, which may be referred to as “a-la-carte”; or (ii) in meal kits that include three of the four items that the store carries in inventory pre-packaged together as a “meal kit.” However, the store knows that it has to be mindful in designing its meal kit designs (that is, making three-item selections) because only certain combinations of three food items will form what most people consider as an acceptable meal where the food items blend well together and do not cause bad flavors or nutritionally unbalanced meals. In this example, the three (3) item meal kit is a specific example of a larger concept, known as an “ensemble.” For purposes of this document, an ensemble is defined as a pre-defined combination of items (of any sort) that can be purchased together as a set by customers.

Processing begins at operation S255, where first input module (“mod”) 302 receives a candidate data set (from client subsystem 104 and over communication network 114) that includes identifying information for all of the possible candidate food items that can be stocked in the inventory of the food store, and, also, the number of candidates that are to be found eligible to go into inventory (in this case, four (4) candidates are to be selected, as mentioned in the previous paragraph).

In this example there are nine (9) candidate items: (A) acorn squash; (B) beets; (C) carrots; (D) dill; (E) eggplant; (F) fennel; (G) garlic; (H) hot sauce; and (I) iceberg lettuce. However, as mentioned above, the food store has room to carry only four (4) selected items from among the nine (9) candidate items. A process for using machine logic to make this selection will be set forth below in connection with the subsequent operations of the method of flowchart 250. Note: a “selection” may take the form of a recommendation to a set of human individual(s) who make a final decision in view of the recommendations of the embodiment of the present invention. Also, and this probably goes without saying, various embodiments of the present invention are not limited to food type items and also not limited to situations where a store is motivated to limit the selection of candidate items based on physical inventory concerns—there may be other reasons for various types of stores to limit the number of items that they want to sell, or want to sell specifically in ensemble form.

Processing proceeds to operation S260, where second input mod 304 receives an ensemble data set from client subsystem 104 and over communication network 114. In this example, the ensemble data set includes: (i) an identification of all possible sub-combinations of the candidate items that include at least three of the potential candidate items; and (ii) for each possible sub-combination, an expert “ensemble strength rating” that corresponds to the degree of the proposed ensemble for purchasing together as a set (in this example, in the form of a meal kit). In this particular example, the expert rating takes the form of a binary value, specifically: (a) an expert rating of “1” means that the sub-combination would make an acceptable meal kit; and (b) an expert rating of “0” means that the sub combination would not be appropriate for a meal kit. Alternatively, the ensemble strength ratings could come from sources other than experts (for example, artificial intelligence (AI) algorithms, crowdsourcing of non-experts). Also, the ensemble strength ratings may be calculated and/or originally received by the same computer that is performing the method of flowchart 250 (in this example that would be computer 200). The next sub-section of this Detailed description section may contain additional information on various types of ensemble strength ratings and/or how to calculate the same.

Processing proceeds to operation S265 where ensemble-compatibility rating mod 306 determines an ensemble-compatibility rating for each of the nine (9) candidate items. Generally speaking, the ensemble-compatibility rating is a rating value that reflects a degree of compatibility with respect to the item's compatibility to being placed in various ensembles. In this particular example, the ensemble-compatibility rating is calculated, for each given candidate item, by counting up how many sub combinations with an expert rating of “1” (that is, have an ensemble strength rating of “1”) include the given candidate item. Alternatively, ensemble-compatibility ratings may be calculated in other ways, such as by taking every possible four item combination, and calculating separate compatibility ratings for every different four item sub-combination

In this example, the ensemble-compatibility ratings are found, based on the ensemble-strength rating values of the ensemble data set to be as follows: (A) 32; (B) 6; (C) 23; (D) 11; (E) 8; (F) 2; (G) 13; (H) 23; and (I) 20.

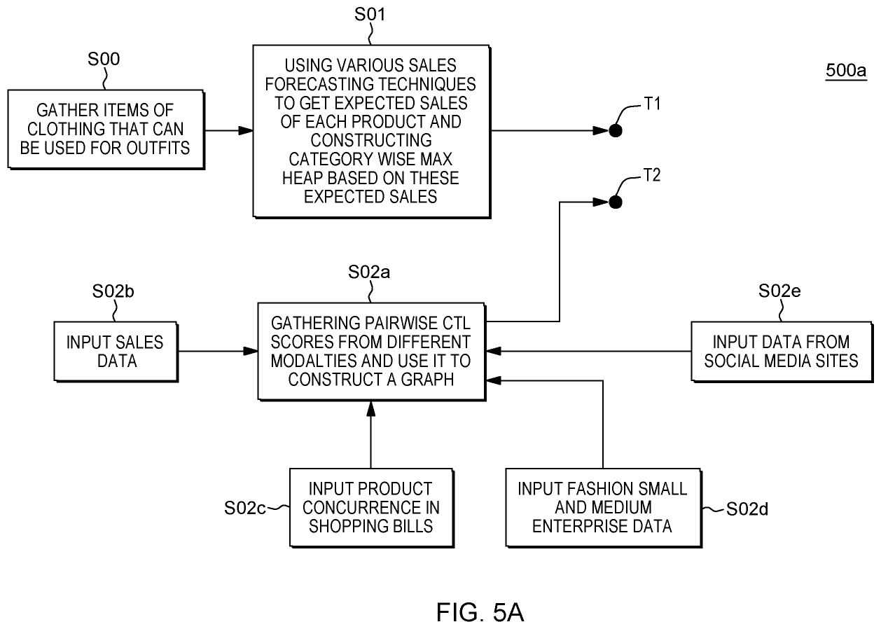

Processing proceeds to operation S270 where candidate selection mod 308 selects four (4) selected items from the nine (9) candidate items, based, at least in part upon the ensemble ratings of the candidate items. In this example, the selection of the selected items is based entirely on the ensemble ratings, and the items with the four highest ensemble ratings (namely A, C, H and I) are the four selected items for the inventory of the store. (See screen shot 400 of FIG. 4.) While this example of FIG. 4 uses foodstuffs to show the breadth and variety and types of “ensembles” that may exist now or come to exist in the future. However, it is noted that one major field of application of many embodiments of the present invention are directed specifically to situations where the items are high fashion garments (that is, relatively expensive garments) and the ensembles take the form of outfits that are sold in package form or combination form to consumers.

Processing proceeds to operation S275 where output mod 310 outputs the identity of the selection made at operation S270 to a set of human individual(s) and/or intelligent computerized agents. In this particular example, output mod 310 outputs the selection by automatically placing orders for acorn squash, carrots, hot sauce and iceberg lettuce over communication network 114 with suppliers at client sub-systems 106, 108, 110, 112. As mentioned above, the selection alternatively may take the form of a recommendation to be considered further by human individual(s) who make the ultimate decision about which candidate items will be carried in inventory.

### III. Further Comments and/or Embodiments

Some embodiments of the present invention recognize one, or more, of the following facts, potential problems and/or potential areas for improvement with respect to the current state of the art: (i) assortment planning is a process whereby products are selected and planned to maximize sales and profit for a specified period of time; (ii) the assortment plan considers the financial objectives and seasonality of merchandise to ensure proper receipt flow; (iii) assortment planning has always been a primary concern for the retailers since they are always trying to strike a balance between optimum shelf space and product selection within that space; (iv) current assortment planning techniques look into products in silos rather than looking them at an outfit level thus are unable to capture the cumulative complementing score of the outfit as a whole; (v) the existing techniques generally try to maximize the revenue but tend to turn a blind eye towards the number of popular outfits that can be generated using the stock; (vi) there is a need to take into account the popularity aspect while at the same time maximize the revenue of the retailer, and this should be done at the outfit level in order to prevent localization of features; (vii) current assortment planning techniques look into products in silos rather than looking them at an outfit level thus are unable to capture the cumulative complementing score of the outfit as a whole; and/or (viii) the existing techniques generally try to maximize the revenue and handle demand transference but do not take into account the number of popular outfits that can be generated using the stock.

Some embodiments of the present invention recognize one, or more, of the following facts, potential problems and/or potential areas for improvement with respect to the current state of the art: (i) outfit is an important parameter for fashion; (ii) fashion drives based on outfit combinations; (iii) people do not shop in isolation; (iv) people shop to complete an outfit for a particular festival/occasion; (v) thus, assortments failing to complete popular outfits doesn't fall under good assortment planning; and/or (vi) several companies have started to sell their products in an outfit-box on an outfit by outfit basis (as opposed to a clothing item by clothing item basis).

A method according to an embodiment of the present invention includes the following operations (not necessarily in the following order): (i) given a category segmented assortment limit constraint, enabling assortment planning of fashion products which maximizes the total number of popular-on-demand outfits as well as revenue; (ii) using sales forecasting technique to get expected sales of each product and constructing category wise max heap based on these expected sales; (iii) gathering pairwise CTL scores (combine-to-leverage scores) from different modalities and use it to construct a graph; (iv) determining the initial assortment state; (v) determining a product to be added to the assortment state at any time step based on certain optimization and popularity score; and (vi) updating the assortment state and heap structure of on the basis of the chosen product.

Some embodiments of the present invention may include one, or more, of the following operations, features, characteristics and/or advantages: (i) given a category segmented assortment limit constraint, enabling assortment planning of fashion products which maximizes the total number of popular-on-demand outfits as well as revenue; (ii) capturing the cumulative complementing score of the outfit as a whole in the context of category constraints (for example, a red shirt can go well with blue jeans, and red shirt can also go well with black jeans—however, given an outfit context such as, red sneakers, then red shirt may not go well with either blue or black jeans; (iii) this outfit combination as a whole constraint is a challenging aspect to consider for assortment planning, especially in the context of category constraints; (iv) solution aspects designed to run efficiently in linear O(K log N) time which can be helpful in production deployments; (v) using sales forecasting technique to get expected sales of each product and constructing category wise max heap based on these expected sales; (vi) an algorithm that explicitly captures mutual compatibility between items to come up with an optimal assortment that maximizes total number of popular outfits along with the revenue while satisfying category segmented assortment limit constraints at the same time; (vii) considers a number of outfits in an assortment to plan for an optimal assortment since mutual compatibility effects increase the sales potential for the outfit items; (viii) however, the combinatorial aspect of the problem hinders getting an accurate forecast for each possible combination of the assortment—thus, some embodiments do not rely on an explicit sales forecast for a particular assortment; (ix) optimizes the assortment as a whole to maximize the number of outfits along with the revenue while satisfying category segmented assortment limit constraints at the same time; and/or (x) captures the cumulative complementing score of the outfit as a whole in the context of category constraints.

Some embodiments of the present invention may include one, or more, of the following operations, features, characteristics and/or advantages: (i) fashion outfit based assortment planning; (ii) machine logic for assortment planning, such that the assortment determined or recommended by the machine logic maximizes both revenue and number of popular outfits given certain constraints (for example, there is an upper limit on the number of products of each category that we can stock); (iii) outfit is different than complementarity because outfit considers compatibility between multiple items rather than just pairs of items; (iv) this outfit as a whole constraint is a challenging aspect to consider for assortment planning; (v) maximizes popular outfits while satisfying category constraints; (vi) modelling outfit constraints is different and more challenging than modelling complementarity; (vii) given a category segmented assortment limit constraint, the notion of enabling assortment planning of fashion products which maximizes the total number of popular-on-demand outfits as well as revenue; and/or (viii) captures the cumulative complementing score of the outfit as a whole in the context of category constraints.

Some embodiments of the present invention may include one, or more, of the following operations, features, characteristics and/or advantages: (i) given a category segmented assortment limit constraint, the notion of enabling assortment planning of fashion products which maximizes the total number of popular-on-demand outfits as well as revenue; (ii) the machine logic considers outfit-level interactions spanning multiple product categories, thus making the approach more general; (iii) explicitly models interactions between the products based on the CTL scores and perform a constraint optimization; (iv) compatibility between a set of products is explicitly modelled; (v) takes into account categorical constraints and number of outfits as a metric for the assortment; and/or (vi) takes into account of capturing the cumulative complementing score of the outfit as a whole in the context of category constraints.

As an example of item (vi) in the list of the foregoing paragraph, assume a red shirt can go well with blue jeans, and that red shirt can also go well with black jeans. However, given an outfit context such as, red sneakers, then red shirt may not go well with either blue or black jeans. This outfit as a whole constraint is a challenging aspect to consider for assortment planning. This challenging aspect may be addressed by some embodiments of the present invention. Also, enabling whole-outfit-consideration (that is, three or more clothing items) in the context of category constraints is another challenging aspect which some embodiments may address.

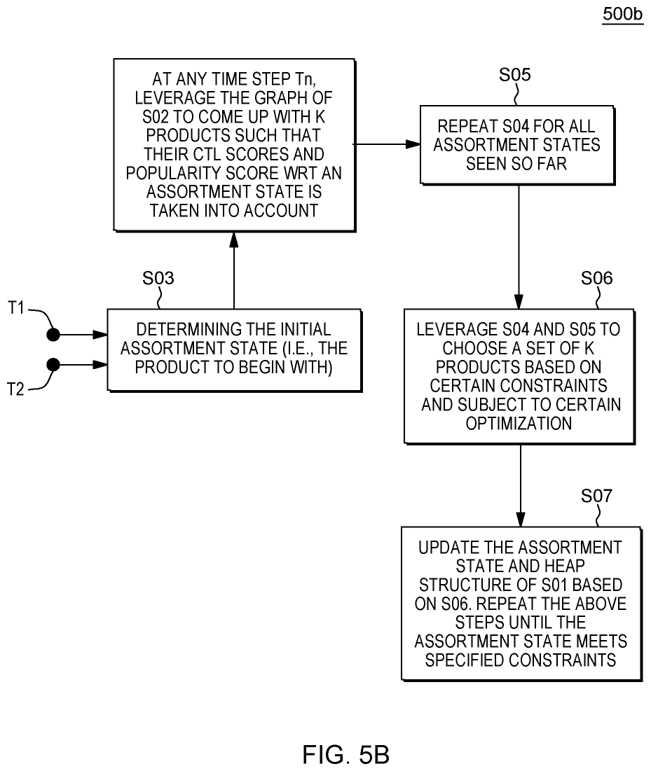

As shown in FIGS. 5A and 5B, flow chart 500 (including 500a portion of FIG. 5A and 500b portion of FIG. 5B, which can be joined at process flow junctures T1 and T2) shows a high level solution that includes the following operations (with process flow among and between the various operations as shown by arrows in FIGS. 5A and 5B): S00, S01, S02 (including the following sub-operations S02a, S02b, S02c, S02d and S02e); S03; S04; S05; S06 and S07.

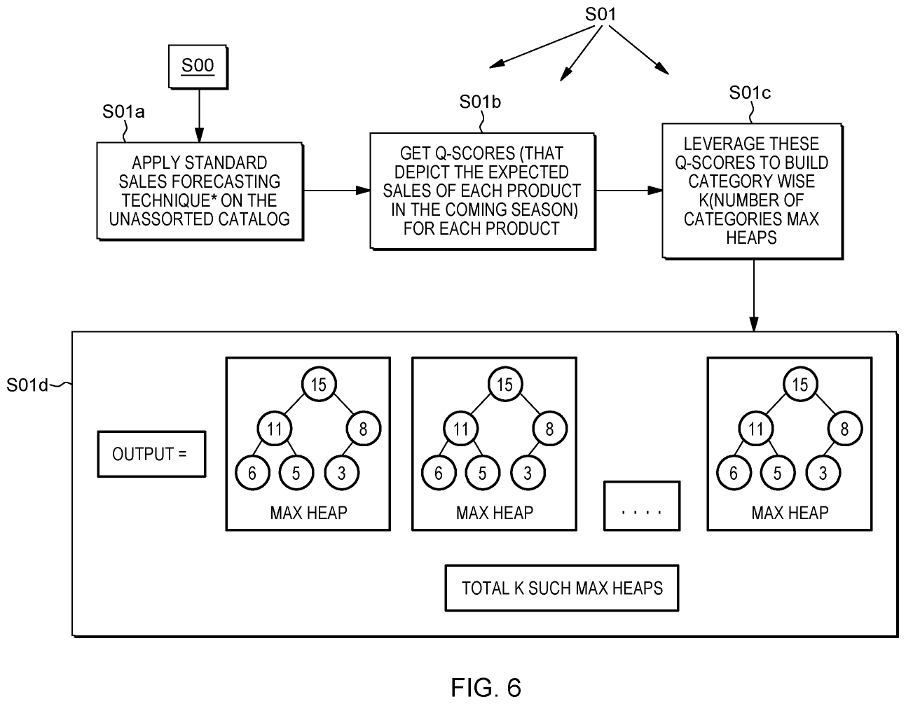

As shown in FIG. 6, step S01 includes the following sub-operations: S01a; S01b; S01c; and S01d. As shown in FIG. 6, the output of sub-operation S01d is a set of “max heaps” that have multiple nodes arranged in a hierarchical tree structure by the connections among and between the various nodes of the max heaps. As shown in FIG. 6: (i) sales forecasting technique are used to obtain q-scores for each product (that is, each individual item of clothing); (ii) these q-scores are leveraged to build category wise max-heaps (see sub-operation block S01d); (iii) because the machine logic of this embodiment of the present invention uses max heap data structures, this means that at any point there exists the option of adding a product to current assortment state from each of the root nodes of the K heaps; and (iv) the basis of choosing one of these K root nodes and subsequent updating of heap will be further discussed below.

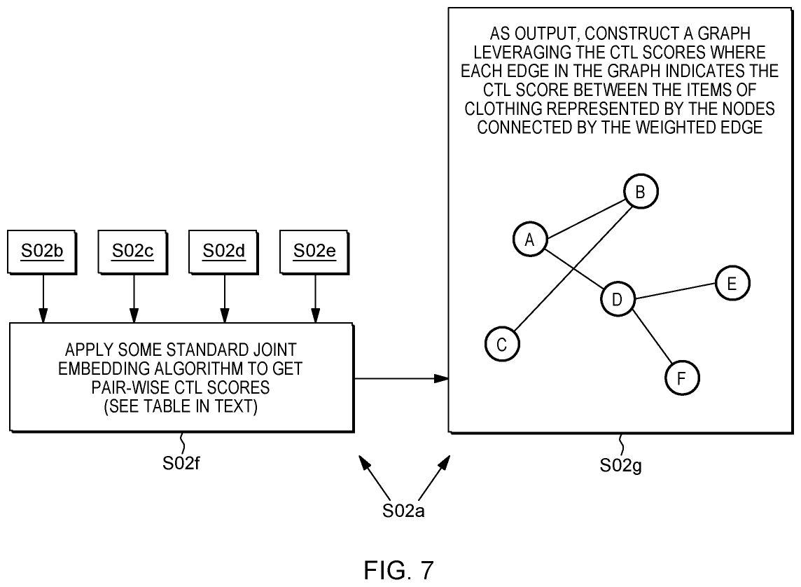

As shown in FIG. 7, sub-operation S02a includes sub-sub-operations S02f and S02g. Sub-sub-operation S02f makes a reference to a pairwise CTL score table, called Table (1):

| P1 | P2 | CTL score |
|---|---|---|
| Grey round neck t-shirt | Blue jeans | 0.5 |
| Blue jeans | Pink canvas shoes | 0.02 |
| Pink jacket | Black jeans | 0.03 |
| Magenta shirt | Olive jeans | 0.7 |

The following notes relate to FIG. 7: (i) for each product, the top ‘n’ pairwise CTL scores are retained; (ii) CTL score depicts the amount by which the products complement each other; and (iii) CTL score lies between (0-1). The process flow from sub-operations S02b, S02c, S02d and S02e into sub-sub-operation S02f represents a gathering current trends to use as an input.

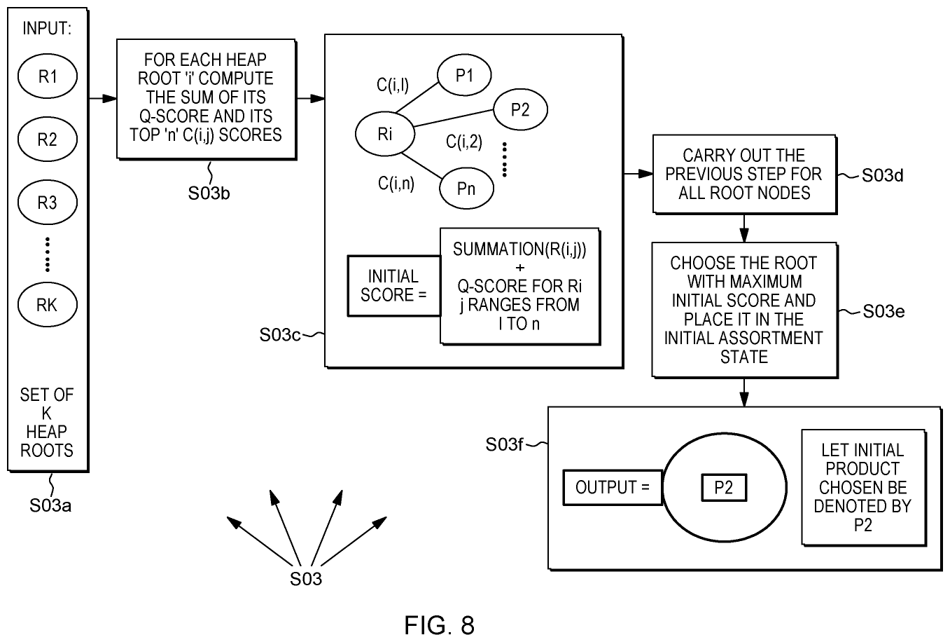

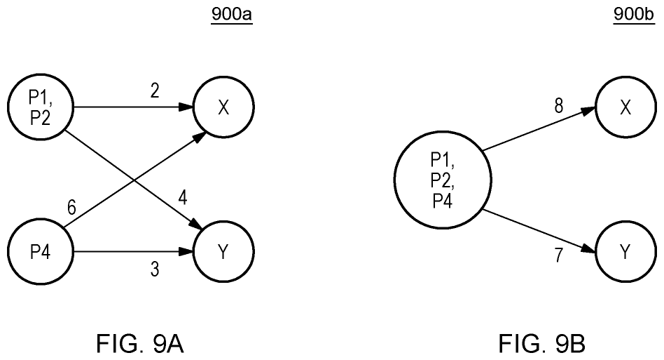

As shown in FIG. 8, operation S03 includes the following sub-operations: S03a; S03b; S03c; S03d; S03e and S03f. In general terms, operation S03 determines the initial assortment state. As shown in FIG. 9A, operation S03 generates graph 900a, which is a graph that represents the situation before clubbing P4 with P1, P2. As shown in FIG. 9B, operation S03 also generates graph 900b, which is a graph that represents the situation after clubbing P4 with P1, P2. At the end of each time step, the machine logic of this embodiment of the present invention clubs the product chosen in that time step with the current assortment state to form a new pseudo node as illustrated by graphs 900a, 900b. While clubbing into pseudo node, the original node is retained.

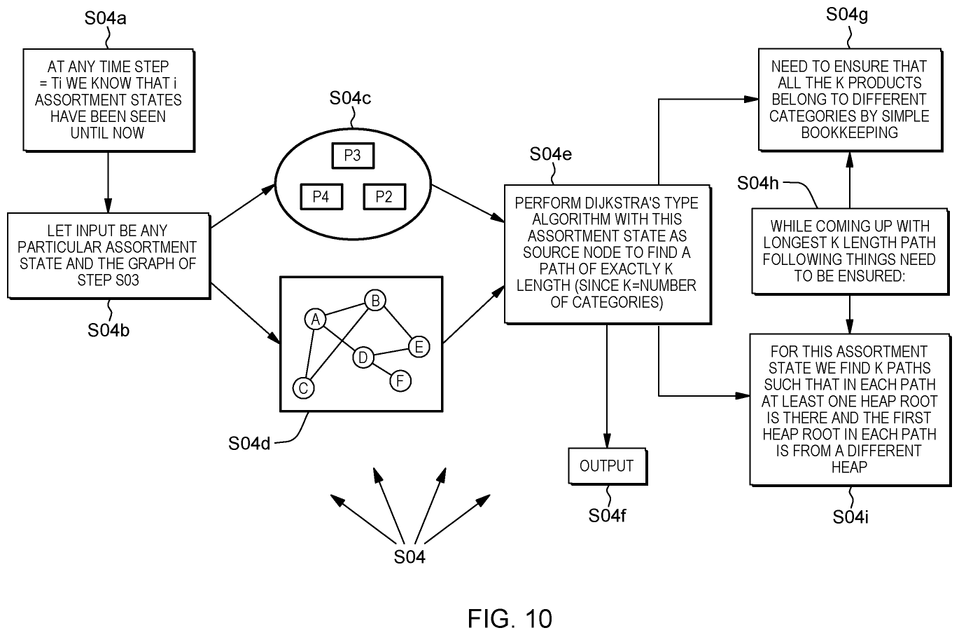

As shown in FIG. 10, operations S04 includes the following sub-operations: S04a; S04b; S04c; S04d; S04e; S04f; S04g; S04h; and S04i. Collectively, the foregoing sub-operations determine the product to be added to the assortment state at any given time. Some notes on operation S04 follow: (i) putting constraint of path length=K helps to look at CTL scores in at outfit level (at least three items of clothing) and not individually or in mere pairs; (ii) because this embodiment has adopted max heap, the machine logic is inherently bound to choose one of the heap roots at each time step; (iii) ensuring first heap root is different in each of the K paths helps to find popularity of the heap root with respect to the assortment state under consideration; and (iv) the product popularity score is inversely proportional to the distance of the chosen heap root from the source node in the corresponding path.

Referring back to flowchart 500 of FIGS. 5A and 5B, operation S05 repeats operation S04 for all of the assortment states encountered up to this point in the process. Some points regarding the significance of S05 are as follows: (i) given an assortment state, if the machine logic finds a popularity score of a heap root with respect to all possible subsets of the assortment state the result is a relatively large degree of computational expense; (ii) some embodiments look only at those subsets that have been an assortment state in the past, which potentially reduces the amount of computational power required; and (iii) at time step=Tᵢ the machine logic finds K paths for each of the assortment states encountered up to this point in the process.

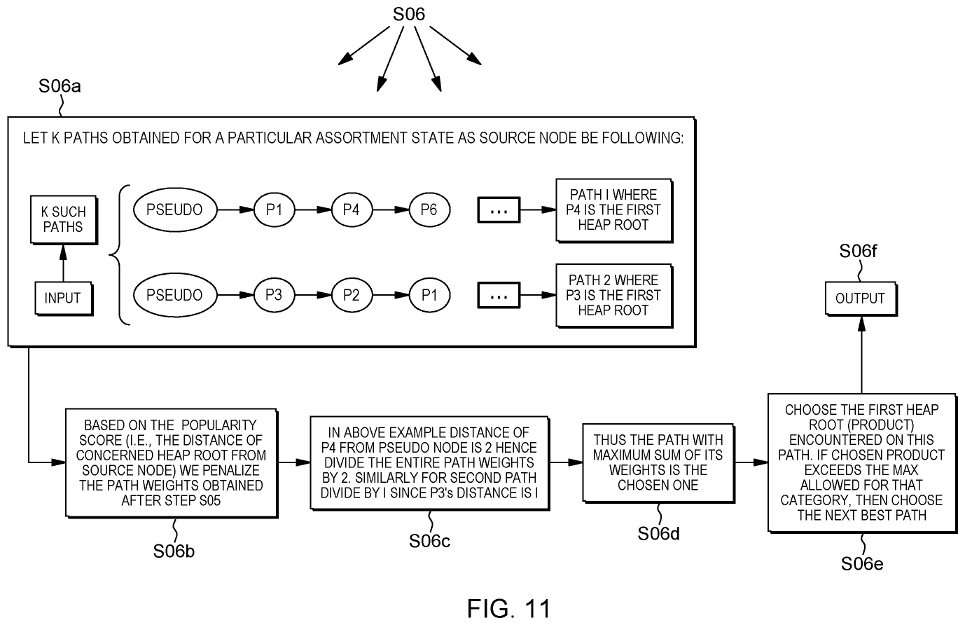

As shown in FIG. 11, operation S06 includes the following sub-operations (with process flow among and between the sub-operations as shown by arrows in FIG. 11: S06a; S06b; S06c; S06d; S06e; and S06f. As further shown in FIG. 11, sub-operation S06a involves K paths, where each path starts with a pseudonode, where each path has a first heap root.

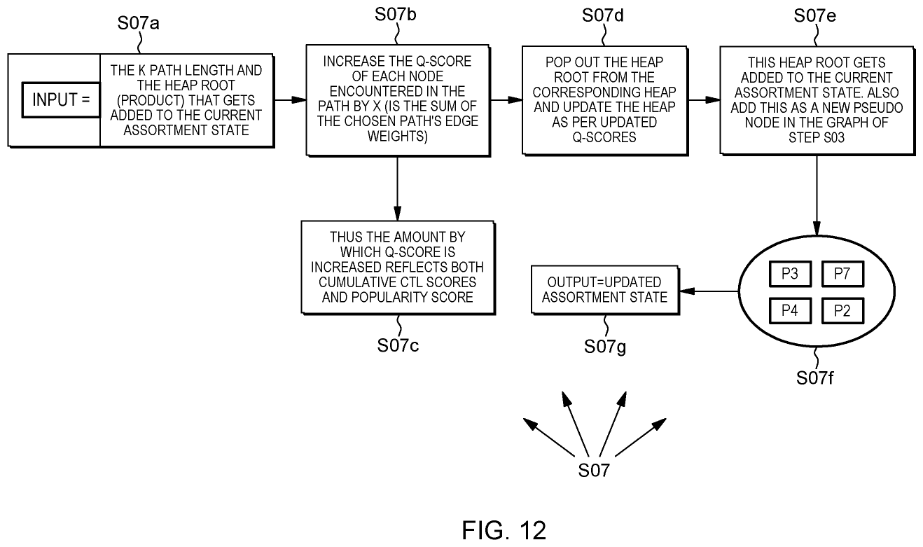

As shown in FIG. 12, operation S07 includes the following sub-operations (with process flow among and between the sub-operations as shown by arrows in FIG. 12: S07a; S07b; S07c; S07d; S07e; S07f; and S07g.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

What is claimed is:

1. A computer-implemented method (CIM) comprising:
receiving a candidate data set that includes identifying information for a plurality of candidate items are available that be stocked in an inventory of a store;
determining a plurality of candidate ensembles, with each candidate ensemble being made up of at least three candidate items of the plurality of candidate items;
for each given candidate item of the plurality of candidate items, determining a number of candidate ensembles to which the given candidate item belongs to determine an ensemble-compatibility rating for the given candidate item; and
selecting a plurality of recommended inventory items from the candidate items, based, at least in part, upon the ensemble-compatibility ratings of the candidate items.

2. The CIM of claim 1 further comprising:
communicating an identity of the plurality of recommended inventory items to a human individual that controls inventory of the store.

3. The CIM of claim 1 further comprising:
automatically ordering at least one of the recommended inventory items.

4. The CIM of claim 1 wherein:
each candidate item is an article of clothing; and
each candidate ensemble of the plurality of candidate ensembles is an outfit made up of at least three articles of clothing.

5. The CIM of claim 1 wherein the determination of the plurality of candidate ensembles is based upon at least one of the following: expert input information regarding which ensembles are likely to be profitable for the store and/or recommendations for a machine learning algorithm recommendations regarding which ensembles are likely to be profitable for the store.

6. The CIM of claim 1 further comprising:
optimizes an assortment as a whole to maximize a number of ensembles along with revenue while satisfying category segmented assortment limit constraints.

7. A computer-implemented method (CIM) comprising:
receiving a candidate data set that includes identifying information for a plurality of candidate items are available that be stocked in an inventory of a store;
determining a plurality of candidate ensembles, with each candidate ensemble being made up of at least three candidate items of the plurality of candidate items;
for each given candidate item of the plurality of candidate items, determining an ensemble-compatibility rating for the given candidate item based, at least in part, upon relative predicted popularity of candidate ensembles to which the given candidate item belongs; and
selecting a plurality of recommended inventory items from the candidate items, based, at least in part, upon the ensemble-compatibility ratings of the candidate items.

8. The CIM of claim 7 further comprising:
communicating an identity of the plurality of recommended inventory items to a human individual that controls inventory of the store.

9. The CIM of claim 7 further comprising:
automatically ordering at least one of the recommended inventory items.

10. The CIM of claim 7 wherein:
each candidate item is an article of clothing; and
each candidate ensemble of the plurality of candidate ensembles is an outfit made up of at least three articles of clothing.

11. The CIM of claim 7 wherein the determination of the plurality of candidate ensembles is based upon at least one of the following: expert input information regarding which ensembles are likely to be profitable for the store and/or recommendations for a machine learning algorithm recommendations regarding which ensembles are likely to be profitable for the store.

12. The CIM of claim 7 further comprising:
optimizes an assortment as a whole to maximize a number of ensembles along with revenue while satisfying category segmented assortment limit constraints.

13. A computer-implemented method (CIM) comprising:
receiving a candidate data set that includes identifying information for a plurality of candidate items are available that be stocked in an inventory of a store;
determining a plurality of candidate ensembles, with each candidate ensemble being made up of at least three candidate items of the plurality of candidate items;
for each given candidate item of the plurality of candidate items, determining an ensemble-compatibility rating for the given candidate item based, at least in part, upon all of the following: (i) relative predicted popularity of candidate ensembles to which the given candidate item belongs; (ii) number of candidate ensembles to which the given candidate item belongs; and (iii) profit margins associated with the candidate ensembles to which the candidate item belongs; and
selecting a plurality of recommended inventory items from the candidate items, based, at least in part, upon the ensemble-compatibility ratings of the candidate items.

14. The CIM of claim 13 further comprising:
communicating an identity of the plurality of recommended inventory items to a human individual that controls inventory of the store.

15. The CIM of claim 13 further comprising:
automatically ordering at least one of the recommended inventory items.

16. The CIM of claim 13 wherein:
each candidate item is an article of clothing; and
each candidate ensemble of the plurality of candidate ensembles is an outfit made up of at least three articles of clothing.

17. The CIM of claim 13 wherein the determination of the plurality of candidate ensembles is based upon at least one of the following: expert input information regarding which ensembles are likely to be profitable for the store and/or recommendations for a machine learning algorithm recommendations regarding which ensembles are likely to be profitable for the store.

18. The CIM of claim 13 further comprising:
optimizes an assortment as a whole to maximize a number of ensembles along with revenue while satisfying category segmented assortment limit constraints.
